(19) United States
(12) Patent Application Publication
(10) Pub. No.: US 2026/0006426 A1
(43) Pub. Date: Jan. 1, 2026

(54) WI-FI UPLINK WITH BLUETOOTH DOWNLINK OPTIMIZATION

(71) Applicant: Amazon Technologies, Inc., Seattle, WA (US)

(72) Inventors: Srihari Shankar, Newark, CA (US); Tianxiang Zhou, Mountain View, CA (US); Srinath Byregowda, Pleasanton, CA (US); Snehalata Joshi, Newark, CA (US); Adetola Bolade Adeniran, Milpitas, CA (US); Arvind Kandhalu Raghu, Frisco, TX (US); Radhakrishnan Suryanarayanan, Fremont, CA (US)

(21) Appl. No.: 18/757,103

(22) Filed: Jun. 27, 2024

(51) Int. Cl. H04W 8/00; H04L 5/14; H04W 84/12

(52) U.S. Cl. CPC H04W 8/005; H04L 5/1469; H04W 84/12

(57) ABSTRACT

Techniques are generally described for Wi-Fi uplink and Bluetooth downlink optimization. An example method includes initiating a first counter corresponding to a first time period, executing first operation using a first radio during the first time period, and initiating a second counter corresponding to a second time period allotted for the first operation within the first time period. The example method also includes determining a second operation associated with a second radio, and in response to the determination, stopping execution of the first operation, pausing the second counter at a first counter value, and executing the second operation using the second radio during the first time period.

### BACKGROUND

Certain devices may transmit data over Wi-Fi more frequently than others due to application-specific needs, such as continuous monitoring or real-time updates. However, some operations performed by these devices may require Wi-Fi uplink interruption, reducing throughput of the devices.

### BRIEF DESCRIPTION OF THE FIGURES

FIG. 1 is a block diagram illustrating an example system for Wi-Fi transmit with Bluetooth scan optimization, in accordance with various aspects of the present disclosure.

FIG. 2A is an example representation of a time period in which two counters are implemented for managing transmit and scan operations, in accordance with various aspects of the present disclosure.

FIG. 2B is an example representation of a time period in which two counters are implemented for managing transmit and scan operations, in accordance with various aspects of the present disclosure.

FIG. 2C is an example representation of a time period in which two counters are implemented for managing transmit and scan operations, in accordance with various aspects of the present disclosure.

FIG. 2D is an example timing diagram that includes three example time periods in which transmit and scan operations are managed for a system having two antennas, in accordance with various aspects of the present disclosure.

FIG. 2E is an example timing diagram that includes three example time periods in which transmit and scan operations are managed for a system having one antenna, in accordance with various aspects of the present disclosure.

FIG. 2F is an example timing diagram depicting transmit and scan operations of a system having two antennas for which BLE scanning is not critical, in accordance with various aspects of the present disclosure.

FIG. 2G is an example timing diagram depicting transmit and scan operations of a system having one antenna for which BLE scanning is not critical, in accordance with various aspects of the present disclosure.

FIG. 3 depicts a process for managing transmit and scan operations within a time period, in accordance with various aspects of the present disclosure.

FIG. 4 depicts a process for managing transmit and scan operations within a time period, in accordance with various aspects of the present disclosure.

### DETAILED DESCRIPTION

In the following description, reference is made to the accompanying drawings that illustrate several examples of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Some devices heavily rely on Wi-Fi uplink for transmitting data across a network. Wi-Fi operates on various frequencies (e.g., 2.4 gigahertz (GHz)) and offers fast data transmission rates over long distances. Some devices that utilize Wi-Fi integrate a Wi-Fi radio directly onto a chip, such as a System-on-a-Chip (SoC) which combines various communication, processing, and memory capabilities on a single chip. This integration offers an advantage in that a device can establish connections to Wi-Fi networks without the need for additional external components and allow the device (e.g., a camera, smartphone, smart home device, Internet-of-Things (IoT) device, or the like) to have a reduced form factor.

In some cases, a chip (e.g., an SoC) with an integrated Wi-Fi radio may also integrate a Bluetooth radio on the same chip to provide Bluetooth Low Energy (BLE) communication capabilities. BLE is a wireless communication technology designed for low-power consumption and short-range communications. BLE enables devices to connect and transmit data over short distances, which is ideal for devices such as mobile phones, smartwatches, trackers, IoT devices, and the like.

A device may use its Bluetooth radio to perform BLE transmit and receive operations (e.g. for uplink and downlink operations). For example, in accordance with one or more implementations, gateway devices utilize Wifi for uplink communications to a remote system (e.g. over the internet via a connection to an access point), and utilize BLE for downlink communication with local low-power devices. The local low-power devices utilize BLE for uplink and downlink communications with local gateway devices. The gateway devices and low-power devices may support additional wireless communication approaches as well, e.g. sub-GHz communications using a Long Range (LoRa) modulation scheme, or sub-GHz communications using a frequency shift keying (FSK) modulation scheme.

A device (e.g. a gateway device) may perform a BLE scan, which is a process by which the device scans for and attempts to receive advertisement packets transmitted by nearby BLE advertising devices. As advertisement packets are broadcast periodically by advertising devices (e.g., tags, internet-of-things (IoT) devices, smartphones, wearable devices, and/or the like that are attempting to connect to the device), the device receives and processes the advertising packets to extract information about the advertising devices (e.g., a unique identifier, various supported services, and in some cases payloads of data) and initiate connection requests to establish communication and data exchange using a BLE connection.

In instances in which both a Wi-Fi radio and a Bluetooth radio are co-located (e.g., on the same chip or device), or a single antenna and chipset are used to support both Wi-Fi and Bluetooth communications, interference may occur. Wi-Fi operates in a wideband spectrum, and while this enables high-speed data transmission over longer distances, it also increases the likelihood of interference with other wireless communication technologies, such as Bluetooth, due to signal leakage. For example, because both Wi-Fi and Bluetooth use the 2.4 GHz frequency band, Wi-Fi transmissions can potentially interfere with reception of data by the Bluetooth radio over that band. This interference may result in degraded Bluetooth performance (e.g., reduced range, additional latency, and/or signal loss). In some cases, a device may include only one antenna that is used to facilitate both BLE operations and Wi-Fi operations in an alternating fashion.

To mitigate this interference, it is common for chips to implement coexistence mechanisms in devices that require Wi-Fi transmission and BLE reception functionality. One example coexistence mechanism is Time Division Duplexing (TDD), which divides a communication channel into alternating time slots for transmission and reception. For example, consider a five second time slot in which 50% of the time slot (i.e., 2.5 seconds) is allocated to Wi-Fi transmission (i.e., TX) and the other 50% of the time slot is allocated to BLE reception (i.e., RX). While this may be suitable for some devices, other devices that require significant Wi-Fi transmit to provide adequate output have Wi-Fi airtime sacrificed, in some cases unnecessarily, for BLE scanning. For example, consider the case of a security camera device or video doorbell device operating as a gateway device that periodically performs BLE scans. The security camera device or video doorbell device may often require significant uplink communication in the form of streaming of video. Through existing time dividing solutions, Wi-Fi throughput is proportionately degraded based on how much time is allocated to BLE scanning. For example, consider a five second time slot wherein 2.5 seconds are allocated to Wi-Fi transmit and 2.5 seconds are allocated to BLE scan (e.g., a process in which the device passively scans and attempts to receive advertisement packets transmitted by nearby BLE advertising devices). If a 5 megabit per second (Mbps) throughput is expected, only a 2.5 Mbps throughput is realized.

To solve the above-described issues, example embodiments implement a dynamic counter system within a defined time period (that allocates Wi-Fi transmit and BLE scan operations) which prioritizes and maximizes Wi-Fi transmit while also enabling enough time for BLE scan functionality. Through this counter system, a window of time allocated for BLE scan within the defined time period may be shifted based on Wi-Fi transmit needs, while still ensuring both Wi-Fi transmit and BLE scan are achieved within the defined time period.

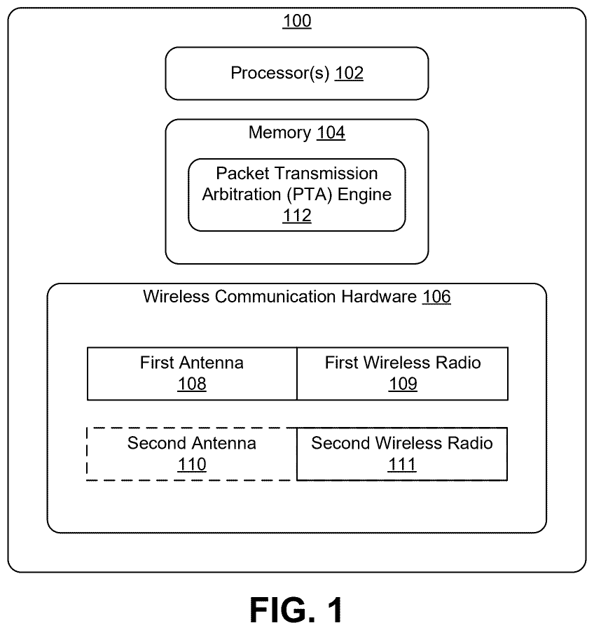

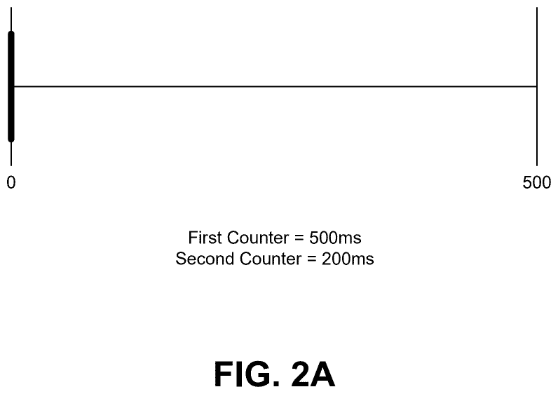

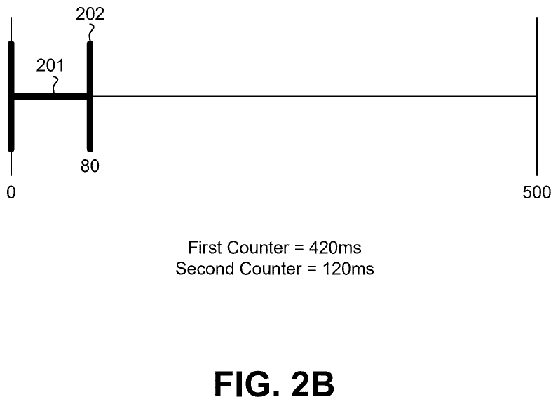

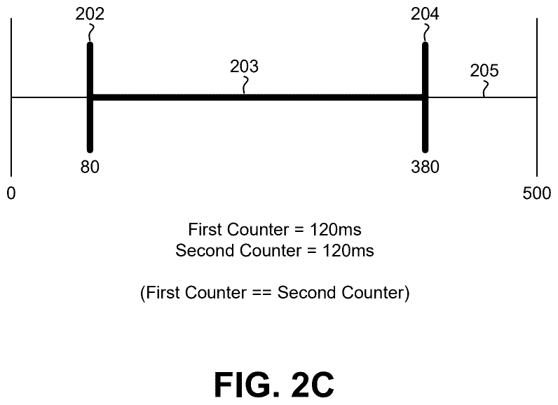

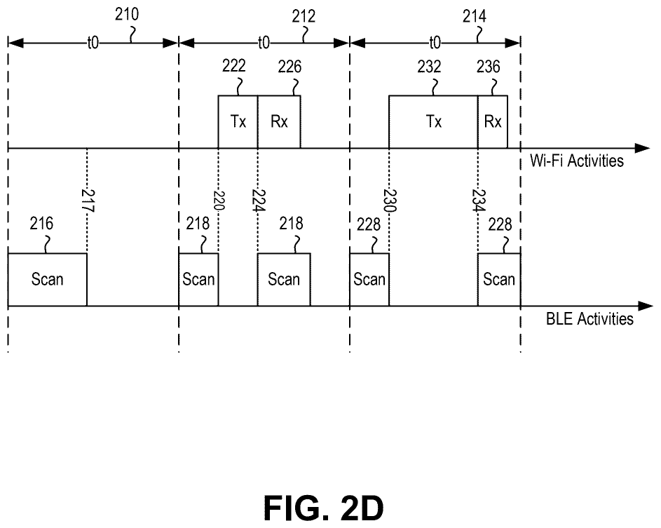

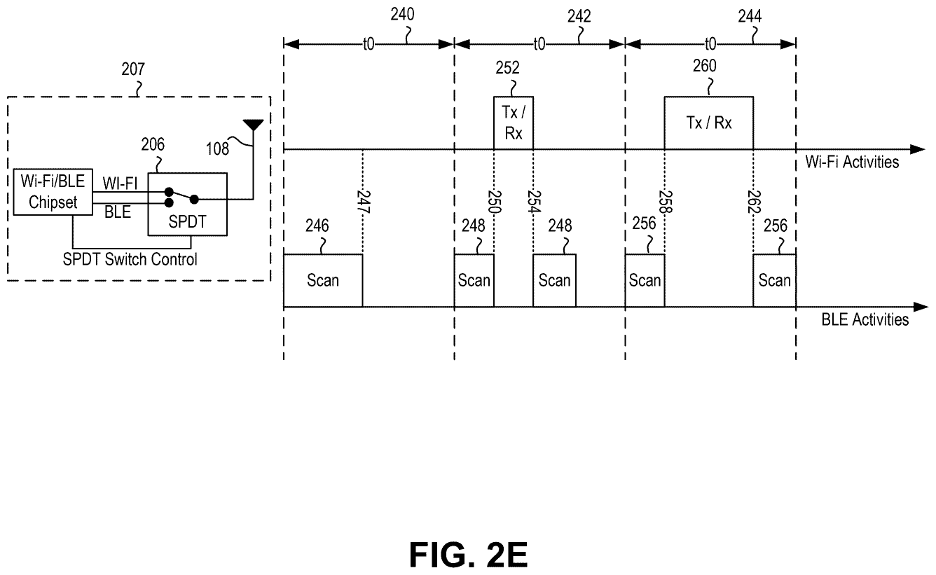

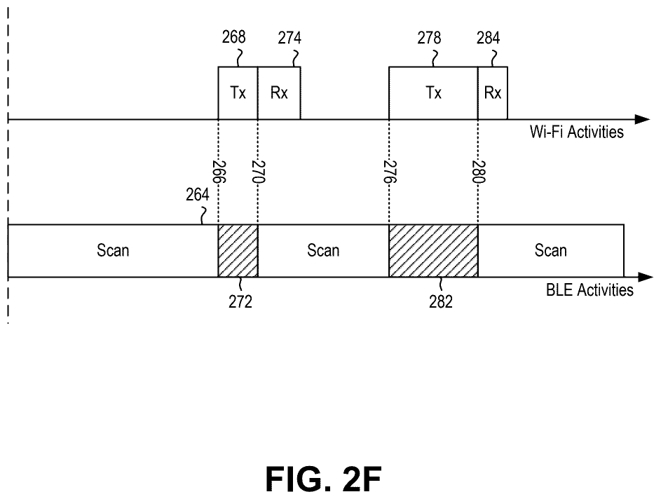

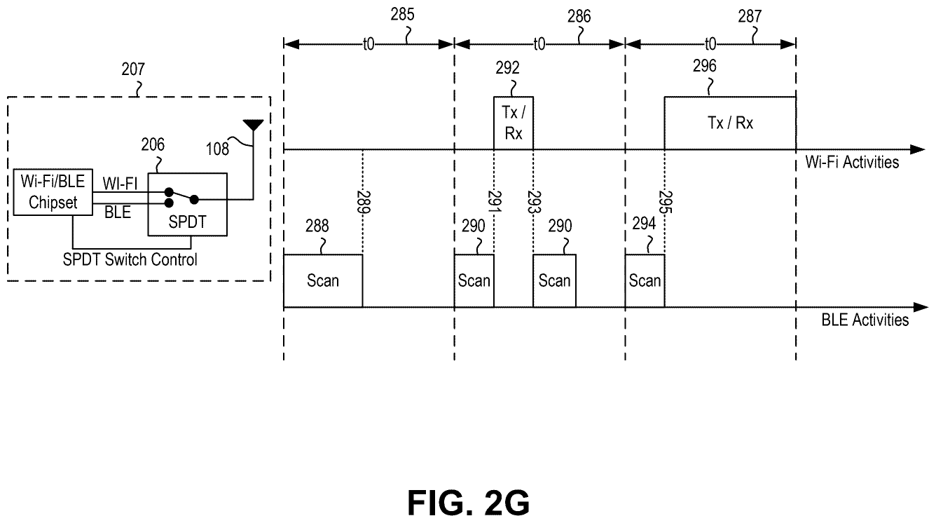

FIG. 1 depicts an example system 100, which may embody various devices for performing example methods in accordance with various aspects of the present disclosure, such as for example, a security camera, smart device, IoT device, and other similar devices. For example, system 100 may include one or more processors 102, memory 104, wireless communication hardware 106 (which includes a first antenna 108 and corresponding first wireless radio 109 and a second wireless radio 111 and, optionally in some embodiments, a second antenna 110 that corresponds to the second wireless radio 111), and Packet Transmission Arbitration (PTA) engine 112 as depicted in FIG. 1. The system 100 depicted in FIG. 2 may include other circuitry and/or hardware not specifically described in connection with FIG. 2 (e.g., additional specialized circuitry, peripherals, etc.) and may be embodied by any computing device known in the art.

The processor(s) 102 may be connected with the memory 104, wireless communication hardware 106, PTA engine 112, and/or any other attached circuitry of the apparatus via a bus for passing information. In some examples, processor(s) 102 may include one or more hardware processors configured in tandem via a bus. The term “processor” as used herein may be understood to include a single core processor, a multi-core processor, multiple processors of the apparatus, remote or “cloud” processors, or any combination thereof.

Memory 104 is non-transitory and may include one or more volatile and/or non-volatile memories. For example, memory 104 may be random access memory, a hard disk, or any other electronic storage device (e.g., a computer readable storage medium). The memory 104 may be configured to store information, data, content, applications, software instructions, or the like, for enabling the apparatus to carry out various functions in accordance with various examples disclosed herein.

The wireless communication hardware 106 may be devices or circuitries embodied in either hardware or a combination of hardware, firmware, and software that are configured to receive and/or transmit data from or to a network and/or any other device wirelessly. Wireless communication hardware 106 may include a network interface and associated devices for communications with a wireless network, such as network interface cards, antennas, buses, switches, routers, modems, supporting hardware, and/or supporting software. The wireless communication hardware 106 may further include processing circuitry for causing transmission or handling receipt of signals to or from a network.

The wireless communication hardware 106 may include radios coupled to antennae for broadcasting and receiving wireless signals. An antenna may be sized and dimensioned to transmit and/or receive signals on a specified wireless signal band comprising a range of wireless signal frequencies. As shown in FIG. 2, wireless communication hardware 106 may include a first antenna 108 coupled to a first wireless radio 109 and a second antenna 110 coupled to a second wireless radio 111.

In various embodiments, the first wireless radio 109 may be a Bluetooth Low Energy (BLE) radio that operates within the 2.4 GHz ISM band via BLE wireless communication technology. BLE technology operates in the same spectrum range (the 2.400-2.4835 GHz ISM band) as classic Bluetooth technology, but uses a different set of channels. Instead of the classic Bluetooth 79 1-MHz channels, Bluetooth Low Energy has 40 2-MHz channels. Within a channel, data is transmitted using Gaussian frequency shift modulation. The first wireless radio 109 (e.g., BLE radio) may employ frequency-hopping spread spectrum (FHSS) techniques and enable short-range wireless communication with other BLE-enabled devices, such as, for example, smartphones, sensors, wearable devices (e.g., smartwatches), and the like through a low-power wireless communication protocol (e.g., Bluetooth 5.0). In various embodiments, the first wireless radio 109 (e.g., BLE radio) may be used to perform downlink operations (i.e., operations in which data is received from other devices) such as BLE scan. BLE scan is a process through which other BLE devices are detected based on broadcasting advertising packets. This may be done using three separate channels (frequencies), in order to reduce interference. The advertising device may send a packet on at least one of these three channels, with a repetition period known as the advertising interval.

In various embodiments, the second wireless radio 111 may be a Wi-Fi radio that operates within the 2.4 GHz and 5 GHz ISM bands. The second wireless radio 111 (e.g., Wi-Fi radio) may employe orthogonal frequency-division multiplexing (OFDM) or another modulation technique to transmit data over multiple channels simultaneously. The second wireless radio 111 may support a plurality of Wi-Fi standards, multiple input multiple output (MIMO) technology, and secure encryption protocols.

The first antenna 108 and second antenna 110 may be sized and dimensioned to transmit and/or receive signals over wireless networks. In various examples, the wireless network may include several frequency bands, and the antennas may be sized and proportioned to use additional frequency bands of the network.

In embodiments in which the system 100 only includes one antenna (e.g., first antenna 108), the first antenna 108 may be used to perform Wi-Fi operations (both receiving and transmitting) and BLE operations (e.g., BLE scan) in an alternating fashion (e.g., subject to TDD or other technique) for respective wireless radios. In this regard, the system 100 may utilize a Single Pole, Double Throw (SPDT) switch (or similar switch) to switch between Wi-Fi and BLE modes and manage sharing of the first antenna 108.

In addition to wireless communication hardware 106, system 100 may further be configured to provide an input/output interface and receive an indication of user input. For example, an apparatus may comprise a display, keyboard, mouse, touch screen, microphone, speaker, and/or other input/output devices. The system 100 may further comprise software enabling a user to interact with the apparatus, including, for example, drivers, graphical user interfaces, web browsers, terminals, and/or the like.

Additionally, system 100 may include a PTA engine 112 (e.g., stored in memory 104) that manages operation of the co-located first wireless radio 109 and second wireless radio 111 within the system 100. In various embodiments, PTA engine 112 may orchestrate prioritization and/or scheduling of packet transmissions between the first wireless radio 109 and second wireless radio 111 (and one or more corresponding antennas) in order to minimize interference and avoid corrupted transmission (TX) and reception (RX) operations. In various embodiments, the PTA engine 112 may employ one or more coexistence mechanisms such as Time Division Duplexing (TDD) or the like to maintain communications. The PTA engine 112 may utilize various mechanisms to determine when a data packet (or plurality of data packets) needs to be transmitted, such as event-driven triggers (e.g., packet arrival in a transmission buffer, requests from one or more applications or protocols, and/or transmission deadlines) and take action to transmit the data packet(s) using one of the first wireless radio 109 or second wireless radio 111. In some examples, each time a protocol intends to perform some operation (such as a transmission), it sends a request to the PTA engine 112. The request may contain multiple pieces of information, such as the operation the protocol intends to perform or the priority level of that operation. The PTA engine 112 may then grant or deny access to the radio-frequency (RF) medium for that request.

In various embodiments, the processor(s) 102, memory 104, wireless communication hardware 106 (including first antenna 108, first wireless radio 109, second antenna 110, and second wireless radio 111), and PTA engine 112 may be co-located on a single semiconductor die (e.g., a System-on-a-Chip (SoC)) to enable compact device design and to optimize power efficiency.

Turning to FIGS. 2A-2C, example representations are shown of an example time period in which two counters are implemented for managing transmit and scan operations. A first counter corresponding to a time (t0) for the example time period and a second counter corresponding to a time (t1) for BLE scan (e.g., BLE scanning) are defined. In these examples shown in FIGS. 2A-2C, t0 corresponds to 500 milliseconds (ms) and t1 corresponds to 200 ms allocated to BLE scan (i.e., receiving) operation(s), such as, for example, BLE scanning, with the remaining 300 ms of the example time period allocated to Wi-Fi transmit (i.e., transmitting) operations, such as, for example, transmitting packet(s) to other devices (e.g., an Access Point (AP) or the like) over Wi-Fi. The first counter (corresponding to the 500 ms example time period), once initiated, may be decremented from 500 each millisecond until it reaches 0. The second counter (corresponding to the 200 ms time period and is initiated upon BLE scan operations (i.e., BLE scanning) beginning within the example 500 ms time period. For example, assume the first 200 ms of the 500 ms window are allocated to BLE scan operations. FIG. 2A provides an example representation of the time period at a point in time where the counters have not yet started. In FIG. 2A, the first counter is at 500 ms, while the second counter is at 200 ms.

As shown in FIG. 2B, after 80 ms has elapsed during which BLE scan operations such as BLE scanning are performed, the second counter may be stopped at point 202 in response to the device determining a packet set (e.g., one or more packets) for Wi-Fi transmission. In other words, if Wi-Fi TX is to be performed, the second counter (which corresponds to the 200 ms allocated to BLE RX) is paused and the BLE RX is stopped, allowing for Wi-Fi TX to then take place. As shown in FIG. 2B, at point 202, a counter value for the first counter is currently at 420 ms, and a counter value for the second counter is currently at 120 ms (since 80 ms has elapsed thus far).

As shown in FIG. 2C, an example Wi-Fi TX (e.g., transmission of one or a plurality of data packets to another device or the like) takes place over a time interval 203 of 300 ms. In some embodiments, counter values of the first counter and second counter are monitored to ensure enough time (e.g., 200 ms) is allotted for BLE RX to take place during the 500 ms time period. Said differently, example embodiments enable a dynamic, shifting BLE RX time window to prioritize Wi-Fi TX when Wi-Fi TX needs to occur when BLE RX is taking place; however, example embodiments may also ensure that BLE RX is not completely overridden by Wi-Fi TX. In this manner, if counter values of the first counter and second counter are determined to equal each other, further Wi-Fi TX may be prevented from taking place during the 500 ms time period and the remainder of time 205 in the 500 ms time period is allocated to BLE RX. Thus, 200 ms of BLE RX and 300 ms of Wi-Fi TX is still realized during the 500 ms time period, with Wi-Fi TX being prioritized as needed.

To provide further examples, FIG. 2D depicts a timing diagram for three example time periods (time period 210, time period 212, and time period 214) in which transmit and scan operations are managed for a system having two antennas (e.g., first antenna 108 corresponding to first wireless radio 109 and second antenna 110 corresponding to second wireless radio 111). The three time periods may be subsequent in that time period 212 begins immediately after time period 210 ends and time period 214 begins immediately after time period 212 ends. Continuing with the example above, a time to for the time periods 210, 212, and 214 may be 500 ms, with 200 ms of the 500 ms allocated to BLE scan operations (e.g., BLE scanning). As shown for example, during time period 210, a BLE scan 216 is performed for an allocated time period (e.g., 200 ms), after which the remainder of time period 210 is allocated to Wi-Fi operations. As shown, no Wi-Fi transmissions needed to occur in time period 210, so BLE scan 216 executed uninterrupted until a time 217 (e.g., when the 200 ms counter corresponding to the time allocated to BLE expired).

During time period 212, a BLE scan 218 is stopped (and the corresponding BLE counter is paused) at time 220 to allow for a Wi-Fi transmission 222 to take place. After the Wi-Fi transmission completes at time 224, the BLE scan 218 is initiated again (and the corresponding BLE counter is resumed) until the allocated time for BLE scan expires (since no other Wi-Fi transmissions need to take place during the time period). As shown, since the example system of FIG. 2D includes two separate antennas, Wi-Fi RX 226 may still take place during BLE RX (e.g., BLE scan 218). Wi-Fi RX 226 may include receiving acknowledgement packets or other like in response to the Wi-Fi transmission 222.

During time period 214, a BLE scan 228 is stopped (and the corresponding BLE counter is paused at a first counter value) at time 230 to allow for a Wi-Fi transmission 232 to take place. As shown, at time 234, it may be determined that the first counter value of the BLE counter equals a current counter value for a counter corresponding to the time period 214 (e.g., a 500 ms counter). In response, the Wi-Fi transmission 232 may be stopped and the remainder of time in time period 214 may be allocated to the BLE scan 228. Again, since the example system of FIG. 2D includes two separate antennas, Wi-Fi RX 236 may still place during BLE RX (e.g., BLE scan 228).

FIG. 2E depicts a timing diagram for three example time periods (time period 240, time period 242, and time period 244) in which transmit and scan operations are managed for an example system 207 having one antenna (e.g., first antenna 108 that is used for both first wireless radio 109 and second wireless radio 111 via an SPDT switch 206 as discussed above). The three time periods may be subsequent in that time period 242 begins immediately after time period 240 ends and time period 244 begins immediately after time period 242 ends. Continuing with the example above, a time to for the time periods 240, 242, and 244 may be 500 ms, with 200 ms of the 500 ms allocated to BLE scan operations (e.g., BLE scanning). As shown for example, during time period 240, a BLE scan 246 is performed for an allocated time period (e.g., 200 ms), after which the remainder of time period 240 is allocated to Wi-Fi operations. As shown, no Wi-Fi transmissions needed to occur in time period 240, so BLE scan 246 executed uninterrupted until a time 247 (e.g., when the 200 ms counter corresponding to the time allocated to BLE expired).

During time period 242, a BLE scan 248 is stopped (and the corresponding BLE counter is paused) at time 250 to allow for a Wi-Fi transmission and/or reception 252 to take place. In this regard, for systems comprising a single antenna, BLE scanning may be paused for a Wi-Fi transmitting operation or a Wi-Fi receiving operation, since Wi-Fi RX cannot occur simultaneously with BLE RX due to the single antenna. After the Wi-Fi transmission or reception 252 completes at time 254, the BLE scan 248 is initiated again (and the corresponding BLE counter is resumed) until the allocated time for BLE scan expires (since no other Wi-Fi transmitting or receiving operations need to take place during the time period).

During time period 244, a BLE scan 256 is stopped (and the corresponding BLE counter is paused at a first counter value) at time 258 to allow for a Wi-Fi transmission or reception 260 to take place. As shown, at time 262, it may be determined that the first counter value of the BLE counter equals a current counter value for a counter corresponding to the time period 244 (e.g., a 500 ms counter). In response, the Wi-Fi transmission or reception 260 may be stopped and the remainder of time in time period 244 may be allocated to the BLE scan 256.

In some embodiments, BLE scanning may not be of critical importance to a system, and thus Wi-Fi operations may always be provided with priority over BLE regardless of time allocated to BLE operations to improve user experience (e.g., a user may not perceive BLE performance degradation). For instance, FIG. 2F is an example timing diagram depicting transmit and scan operations of a system having two antennas for which BLE scanning is not critical (e.g., to overall functionality and/or performance of the system). As shown in FIG. 2F, a BLE scan 264 may be continuously performed over a period of time. From time 266 to time 270, a Wi-Fi transmission 268 may take place, causing an impact 272 to the BLE scan 264. During this time, BLE scanning may still take place only over minimal ranges, such as short distance between a gateway (i.e., the system) to an end node. As the example system in FIG. 2F has two antennas, Wi-Fi RX 274 may continue during BLE scan 264. As the BLE scan 264 continues, another Wi-Fi transmission 278 may take place from time 276 to time 280 that causes another impact 282 to the BLE scan 264 (during which BLE scanning may still take place only over minimal ranges). Again, Wi-Fi RX 284 may continue during BLE scan 264, for example, after the Wi-Fi transmission 278 is complete.

FIG. 2G is an example timing diagram depicting transmit and scan operations of an example system 207 having one antenna (e.g., first antenna 108 that is used for both first wireless radio 109 and second wireless radio 111 via an SPDT switch 206 as discussed above) for which BLE scanning is not critical (e.g., to overall functionality and/or performance of the example system 207). FIG. 2G shows three example time periods (time period 285, time period 286, and time period 287) in which transmit and scan operations are managed for a system having one antenna (e.g., first antenna 108 that is used for both first wireless radio 109 and second wireless radio 111). The three time periods may be subsequent in that time period 286 begins immediately after time period 285 ends and time period 287 begins immediately after time period 286 ends. Continuing with the example above, a time to for the time periods 285, 286, and 287 may be 500 ms, with 200 ms of the 500 ms allocated to BLE scan operations (e.g., BLE scanning). As shown for example, during time period 285, a BLE scan 288 is performed for an allocated time period (e.g., 200 ms), after which the remainder of time period 285 is allocated to Wi-Fi operations. As shown, no Wi-Fi transmissions needed to occur in time period 285, so BLE scan 288 executed uninterrupted until a time 289 (e.g., when the 200 ms counter corresponding to the time allocated to BLE expired).

During time period 286, a BLE scan 290 is stopped (and the corresponding BLE counter is paused) at time 291 to allow for a Wi-Fi transmission and/or reception 252 to take place. In this regard, for systems comprising a single antenna, BLE scanning may be paused for a Wi-Fi transmitting operation or a Wi-Fi receiving operation, since Wi-Fi RX cannot occur simultaneously with BLE RX due to the single antenna. After the Wi-Fi transmission or reception 292 completes at time 293, the BLE scan 290 is initiated again (and the corresponding BLE counter is resumed) until the allocated time for BLE scan expires (since no other Wi-Fi transmitting or receiving operations need to take place during the time period).

During time period 287, a BLE scan 294 is stopped (and the corresponding BLE counter is paused at a first counter value) at time 295 to allow for a Wi-Fi transmission or reception 296 to take place. As shown, since Wi-Fi operations may be prioritized over BLE scan in this example, Wi-Fi transmission or reception 296 may continue through the remainder of time period 287 regardless of whether BLE scan was performed for a full 200 ms.

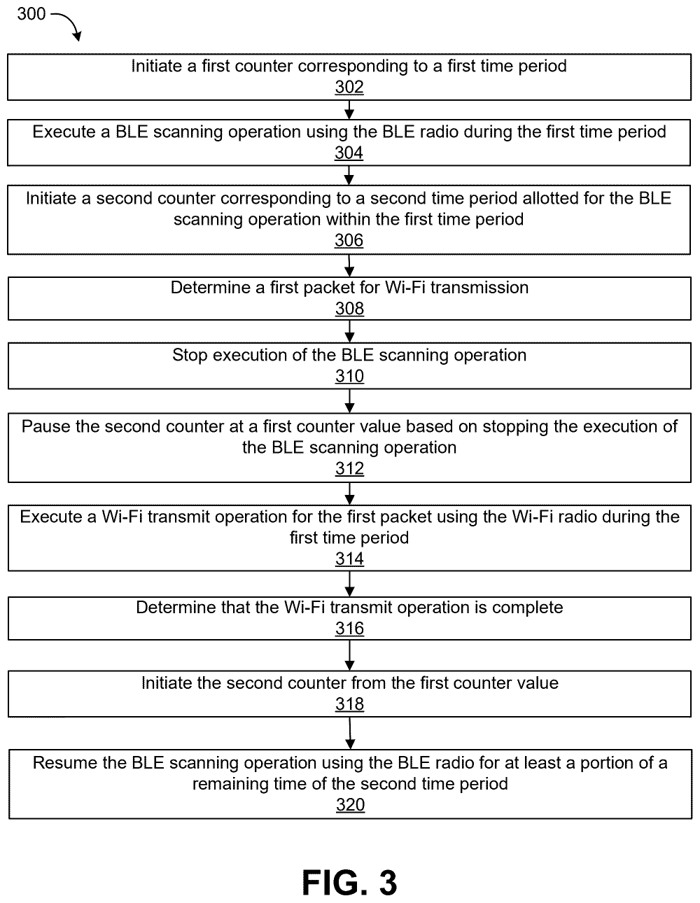

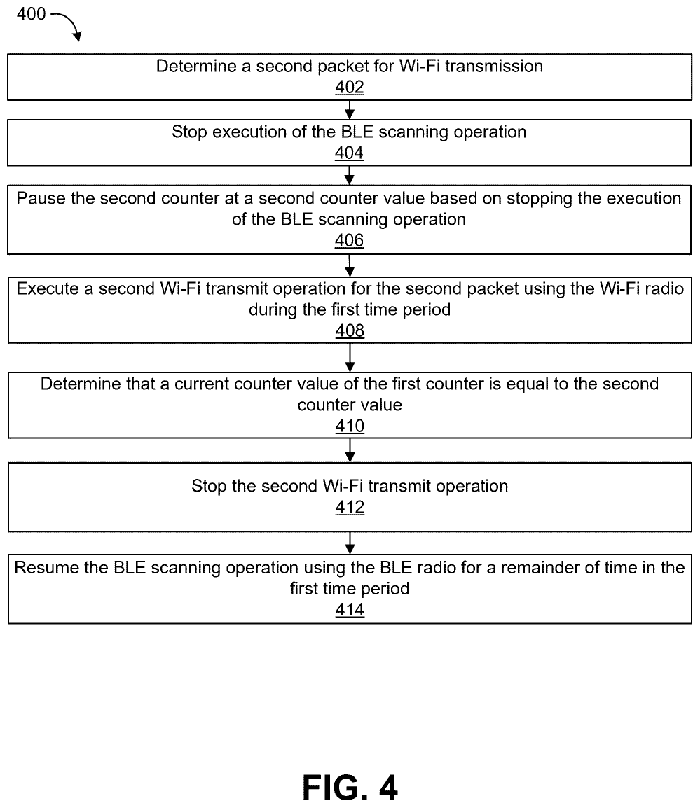

FIGS. 3 and 4 are flowcharts depicting example processes 300 and 400 for managing transmit and scan operations within a time period, in accordance with embodiments of the present disclosure. The process 300 of FIG. 3 and process 400 of FIG. 4 may be executed by one or more computing devices (which may be embodied by system 100 shown in FIG. 1). The actions of processes 300 and 400 may represent a series of instructions comprising computer-readable machine code executable by a processing unit of a computing device. In various examples, the computer-readable machine code may be comprised of instructions selected from a native instruction set of the computing device and/or an operating system of the computing device. Various actions in processes 300 and 400 may be described herein with reference to elements of FIGS. 1-2E. Although shown in a particular order, the steps of processes 300 and 400 may instead be performed in a different order. Additionally, various steps may be performed in parallel in various implementations. Further, some steps may be omitted and/or other steps may be added in accordance with the techniques described herein.

Process 300 may begin at operation 302, at which a first counter corresponding to a first time period is initiated. The first time period may correspond to a Time Division Duplexing (TDD) (or other coexistence mechanism) time slot that allocates a first portion of the first time period to BLE scan and a second portion of the first time period to Wi-Fi transmit. Continuing with the example described above in connection with FIGS. 2A-2C, the first time period may be defined as a 500 millisecond (ms) time period with 200 ms allocated to BLE scan (i.e., receiving or RX) operation(s), such as, for example, BLE scan, and 300 ms allocated to Wi-Fi transmit (i.e., transmitting or TX) operations, such as, for example, transmitting packet(s) to other devices (e.g., an Access Point (AP) or the like) over Wi-Fi. In this regard, the first counter may be initiated and count down (i.e., be decremented each ms) from 500 to 0. While a 500 ms time period is one example, it is to be appreciated that other lengths of time may be defined and used in performing operations described herein.

In various embodiments, the first counter may be initiated by PTA engine 112 of system 100 described above in connection with FIG. 1. As described above, due to a first wireless radio 109 (e.g., BLE radio) and a second wireless radio 111 (e.g., Wi-Fi radio) being co-located (e.g., on the same microchip), the PTA engine 112 may facilitate alternating periods of time for Wi-Fi TX and BLE RX to avoid interference and/or corruption that may occur if both Wi-Fi TX and BLE RX happen simultaneously.

Processing may continue at operation 304, at which a BLE scanning operation is executed using the BLE radio during the first time period. Continuing with the above example, the first 200 ms of the first time period (i.e., a 500 ms time period) may be allocated to BLE RX, such that a BLE scan operation is performed using the BLE radio (e.g., first wireless radio 109) to begin the first time period.

Processing may continue at operation 306, at which a second counter is initiated that corresponds to a second time period allotted for the BLE scanning operation within the first time period. As described in the example above, the second counter may correspond to a 200 ms time period (of the 500 ms first time period) during which BLE RX may take place. The second counter may be initiated and count down (i.e., be decremented each ms) from 200 to 0. While a 200 ms time period for BLE RX is one example, it is to be appreciated that other lengths of time may be defined and used in performing operations described herein.

Processing may continue at operation 308, at which a first packet set for Wi-Fi transmission (or Wi-Fi reception, in examples in which the BLE wireless radio and Wi-Fi wireless radio share a single antenna) is determined. For example, the PTA engine 112 may determine that a first packet set (e.g., one or multiple packets) of data needs to be transmitted using the Wi-Fi radio. The first packet set for Wi-Fi transmission may be determined while BLE RX is taking place (e.g., during the 200 ms allocated for BLE in the 500 ms first time period). The PTA engine 112 may determine the first packet set for Wi-Fi transmission in response to an event-driven trigger, such as packet arrival in a transmission buffer or the like.

Processing may continue at operation 310, at which execution of the BLE scanning operation is stopped. Execution of the BLE scanning operation may be stopped in response to determining the first Wi-Fi packet set for transmission.

Processing may continue at operation 312, at which the second counter is paused at a first counter value based on stopping the execution of the BLE scanning operation. The second counter may be paused (e.g., by PTA engine 112) in conjunction with stopping the execution of the BLE scanning operation.

Processing may continue at operation 314, at which a Wi-Fi transmit operation for the first packet set is executed using the Wi-Fi radio during the first time period. In this regard, the PTA engine 112 may enable the Wi-Fi radio to transmit the first packet set after the BLE scan operation using the BLE radio has stopped to avoid interference that would be introduced by simultaneous Wi-Fi TX and BLE RX.

Processing may continue at operation 316, at which it is determined that the Wi-Fi transmit operation is complete. For example, PTA engine 112 may determine the Wi-Fi transmit operation is complete via feedback from the Wi-Fi radio (e.g., second wireless radio 111), such as a signal or acknowledgement (ACK) received from a receiving device (i.e., a device that received the first packet set). The PTA engine 112 may infer completion of the Wi-Fi transmit operation based on this signal.

Processing may continue at operation 318, at which the second counter is initiated from the first counter value. In this regard, in response to determining that the Wi-Fi transmit operation is complete, the PTA engine 112 may re-initiate the second counter (that corresponds to the 200 ms allocated for BLE scan) from the counter value at which the second counter was paused (e.g., in operation 312).

Processing may continue at operation 320, at which the BLE scanning operation is resumed using the BLE radio for at least a portion of a remaining time of the second time period. The second counter may then continue to decrement each millisecond, during which the BLE scanning operation can continue to be performed.

In some examples, another Wi-Fi packet set may be determined. In this case, the second counter may be paused again, allowing for Wi-Fi TX to take priority over BLE RX. Once the Wi-Fi TX is complete, the second counter and BLE RX may be resumed again. By doing so, devices that require heavy Wi-Fi transmit to ensure adequate performance (e.g., security cameras which may need to maintain steady Wi-Fi transmissions of packets of data corresponding to security footage) are not unnecessarily prevented from performing Wi-Fi TX when needed.

Although the BLE RX time period (e.g., the 200 ms time period) may be shifted and split up throughout the first time period (e.g., the 500 ms time period), example embodiments may also ensure that BLE RX is performed for the allotted time during the first time period, as shown by actions in FIG. 4.

Turning to FIG. 4, processing may continue at operation 402, at which a second packet set for Wi-Fi transmission (or Wi-Fi reception, in examples in which the BLE wireless radio and Wi-Fi wireless radio share a single antenna) is determined. For example, the PTA engine 112 may determine that a second packet set needs to be transmitted using the Wi-Fi radio. The second packet set for Wi-Fi transmission may be determined while BLE RX is taking place, e.g., during the 200 ms allocated for BLE in the 500 ms first time period and after having re-initiated the second counter in operation 318. The PTA engine 112 may determine the second packet set for Wi-Fi transmission in response to an event-driven trigger, such as packet arrival in a transmission buffer or the like.

Processing may continue at operation 404, at which execution of the BLE scanning operation is stopped. Execution of the BLE scanning operation may be stopped in response to determining the second Wi-Fi packet for transmission.

Processing may continue at operation 406, at which the second counter is paused at a second counter value based on stopping the execution of the BLE scan operation. The second counter may be paused (e.g., by PTA engine 112) in conjunction with stopping the execution of the BLE scanning operation (e.g., in operation 404).

Processing may continue at operation 408, at which a second Wi-Fi transmit operation for the second packet set is executed using the Wi-Fi radio during the first time period. As described above, the PTA engine 112 may enable the Wi-Fi radio to transmit the second packet set after the BLE scanning operation using the BLE radio has stopped to avoid interference that would be introduced by simultaneous Wi-Fi TX and BLE RX by the co-located wireless radios.

Processing may continue at operation 410, at which it is determined that a current counter value of the first counter is equal to the second counter value. For example, during execution of the second Wi-Fi transmit operation, the PTA engine 112 may determine that a current counter value for the first counter (which is continuously being decremented each millisecond after initiation in operation 302) is equal to the second counter value (i.e., the counter value at which the second counter is currently paused). For example, the second counter may have been paused at a counter value of 120 ms, meaning that 80 ms has been used so far for BLE RX and 120 ms of BLE RX remains to be used within the 500 ms first time period. If it is determined that a current counter value of the first counter is 120, that means that only 120 ms remain in the 500 ms first time period, and therefore the remaining 120 ms of the first time period must be devoted to BLE RX to meet the requirement of 200 ms of BLE RX within the first time period.

Processing may continue at operation 412, at which the second Wi-Fi transmit operation is stopped. The Wi-Fi transmit operation may be stopped in response to determining that the current counter value of the first counter is equal to the second counter value.

Processing may continue at operation 414, at which the BLE scanning operation is resumed using the BLE radio for a remainder of time in the first time period. In this manner, Wi-Fi TX is prioritized over a first time period through dynamically shifting a BLE RX time window in response to determining packets for Wi-Fi TX, while BLE RX is still also enabled to be performed over the designated amount of time allocated for BLE RX.

Various systems and processes described herein may include or be implemented using or in conjunction with or for a device or electronic device. A device or electronic device may be one or more of a security camera, doorbell camera, webcam, desktop computer, laptop computer, tablet computer, smartphone, wearable device (e.g., headset, smartwatches, smart glasses, etc.), and/or similar electronic devices equipped with physical componentry necessary to perform the various operations described herein. Furthermore, computing devices such as smartphones, laptop computers, tablet computers, and/or wearable devices may generally be referred to as mobile devices.

As set forth above, certain methods or process blocks may be skipped or omitted in some implementations. Blocks or operations may be added to some implementations. The methods and processes described herein are also not limited to any particular sequence or order, and the blocks or operations relating thereto can be performed in other sequences or orders that are appropriate. For example, described blocks or operations may be performed in an order other than that specifically disclosed, or multiple blocks or operations may be combined in a single block or state. For instance, two or more blocks or operations may be executed concurrently or with partial concurrence. The example blocks or operations may be performed in serial, in parallel, or in some other manner. For example, the order of execution of two or more blocks or operations may be scrambled relative to the order described. For instance, two or more blocks or operations may be executed concurrently or with partial concurrence. It is understood that all such variations are within the scope of the present disclosure.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. The various features and processes described above may be used independently of one another or may be combined in various ways. All possible combinations and sub-combinations are intended to fall within the scope of this disclosure.

In addition, conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Although this disclosure has been described in terms of certain example embodiments and applications, other embodiments and applications that are apparent to those of ordinary skill in the art, including embodiments and applications that do not provide all of the benefits described herein, are also within the scope of this disclosure. The scope of the inventions is defined only by the claims, which are intended to be construed without reference to any definitions that may be explicitly or implicitly included in any incorporated-by-reference materials.

What is claimed is:

1. An electronic device comprising:
a Bluetooth Low Energy (BLE) radio;
a Wi-Fi radio;
one or more processors; and
one or more computer readable media storing processor-executable instructions which, when executed using the one or more processors, cause the system to perform operations comprising:
initiating a first counter corresponding to a first time period;
executing a BLE scanning operation using the BLE radio during the first time period;
initiating a second counter corresponding to a second time period allotted for the BLE scanning operation within the first time period;
determining a first packet set for Wi-Fi transmission;
in response to determining the first packet set for Wi-Fi transmission:
stopping execution of the BLE scanning operation,
pausing the second counter at a first counter value based on stopping the execution of the BLE scanning operation, and
executing a Wi-Fi transmit operation for the first packet set using the Wi-Fi radio during the first time period;
determining that the Wi-Fi transmit operation is complete; and
in response to determining that the Wi-Fi transmit operation is complete:
initiating the second counter from the first counter value, and
resuming the BLE scanning operation using the BLE radio for at least a portion of a remaining time of the second time period.

2. The system of claim 1, wherein the one or more computer readable media further stores processor-executable instructions which, when executed using the one or more processors, cause the system to perform operations comprising:
determining a second packet set for Wi-Fi transmission;
in response to determining the second packet set for Wi-Fi transmission:
stopping execution of the BLE scanning operation,
pausing the second counter at a second counter value based on stopping the execution of the BLE scanning operation, and
executing a second Wi-Fi uplink operation for the second packet set using the Wi-Fi radio during the first time period;
determining that a current counter value of the first counter is equal to the second counter value; and
in response to determining that the current counter value of the first counter is equal to the second counter value:
stopping the second Wi-Fi uplink operation; and
resuming the BLE scanning operation using the BLE radio for a remainder of time in the first time period.

3. The system of claim 1, wherein the first time period corresponds to a Time Division Duplexing (TDD) slot that allocates a first portion of the first time period to BLE scanning and a second portion of the first time period to Wi-Fi uplink.

4. The system of claim 1, wherein the BLE radio and the Wi-Fi radio are co-located on a microchip such that interference occurs when downlink occurs using the BLE radio and uplink occurs using the Wi-Fi radio simultaneously.

5. An electronic device comprising:
one or more radios;
one or more processors; and
one or more computer readable media storing processor-executable instructions which, when executed using the one or more processors, cause the system to perform operations comprising:
initiating a first counter associated with a first time period,
initiating a second counter associated with scanning,
operating in a scanning mode of operation comprising determining, based on one or more signals received using at least one of the one or more radios, whether an advertisement packet has been received,
determining that a wireless packet needs to be transmitted,
based on determining that a wireless packet needs to be transmitted,
ceasing to operate in the scanning mode of operation,
pausing the second counter, and
transmitting the wireless packet using at least one of the one or more radios.

6. The electronic device of claim 5, wherein the one or more computer readable media store processor-executable instructions which, when executed using the one or more processors, cause the system to perform operations comprising
based on determining that a transmission operation is complete,
resuming the second counter, and
operating in the scanning mode of operation.

7. The electronic device of claim 5, wherein operating in the scanning mode of operation comprises determining, based on one or more signals received using at least one of the one or more radios, whether a Bluetooth Low Energy (BLE) advertisement packet has been received.

8. The electronic device of claim 5, wherein the electronic device comprises a Wifi radio and a Bluetooth Low Energy (BLE) radio.

9. The electronic device of claim 5, wherein the one or more radios comprise a first radio configured for Wifi and Bluetooth Low Energy (BLE) communications.

10. The electronic device of claim 5, wherein transmitting the wireless packet represents a Wifi transmit operation.

11. The electronic device of claim 5, wherein operating in a scanning mode of operation comprises operating in a passive scanning mode.

12. The electronic device of claim 5, wherein operating in a scanning mode of operation comprises operating in an active scanning mode, and wherein the one or more computer readable media store processor-executable instructions which, when executed using the one or more processors, cause the system to perform operations comprising in response to detecting an advertisement packet, transmitting a scan request.

13. An electronic device comprising:
one or more radios;
one or more processors; and
one or more computer readable media storing processor-executable instructions which, when executed using the one or more processors, cause the system to perform operations comprising:
initiating a first counter associated with a first time period,
initiating a second counter associated with scanning,
operating in a scanning mode of operation comprising determining, based on one or more signals received using at least one of the one or more radios, whether an advertisement packet has been received,
determining that one or more transmission operations need to be performed,
based on determining that one or more transmission operations need to be performed,
ceasing to operate in the scanning mode of operation,
pausing the second counter, and
effecting transmission of one or more wireless signals,
based on the first counter and the second counter,
ceasing transmission of one or more wireless signals, and
operating in the scanning mode of operation.

14. The electronic device of claim 5, wherein the one or more computer readable media store processor-executable instructions which, when executed using the one or more processors, cause the system to perform operations comprising
comparing the first counter to the second counter;
wherein the ceasing of the transmission of one or more wireless signals is based on the comparing of the first counter to the second counter.

15. The electronic device of claim 5, wherein the one or more computer readable media store processor-executable instructions which, when executed using the one or more processors, cause the system to perform operations comprising
determining, based on the first counter and the second counter, that an amount of time left in the first time period corresponds to an amount of time left on the second counter;
wherein the ceasing of the transmission of one or more wireless signals is based on the determining, based on the first counter and the second counter, that an amount of time left in the first time period corresponds to an amount of time left on the second counter.

16. The electronic device of claim 13, wherein operating in the scanning mode of operation comprises determining, based on one or more signals received using at least one of the one or more radios, whether a Bluetooth Low Energy (BLE) advertisement packet has been received.

17. The electronic device of claim 13, wherein the electronic device comprises a Wifi radio and a Bluetooth Low Energy (BLE) radio.

18. The electronic device of claim 13, wherein the one or more radios comprise a first radio configured for Wifi and Bluetooth Low Energy (BLE) communications.

19. The electronic device of claim 13, wherein operating in a scanning mode of operation comprises operating in a passive scanning mode.

20. The electronic device of claim 13, wherein operating in a scanning mode of operation comprises operating in an active scanning mode, and wherein the one or more computer readable media store processor-executable instructions which, when executed using the one or more processors, cause the system to perform operations comprising
in response to detecting an advertisement packet, transmitting a scan request.
